(19) United States
(12) Patent Application Publication
(10) Pub. No.: US 2011/0164910 A1
(43) Pub. Date: Jul. 7, 2011

(54) THIN KEYPAD ASSEMBLY AND METHOD FOR MANUFACTURING SAME

(75) Inventors: Hitoshi Ando, Saitama (JP); Masahide Takahashi, Saitama (JP); Shinji Hotta, Saitama (JP)

(73) Assignee: SHIN-ETSU POLYMER CO., LTD., Tokyo (JP)

(21) Appl. No.: 12/947,950

(22) Filed: Nov. 17, 2010

(30) Foreign Application Priority Data
Jan. 6, 2010 (JP) 2010-001163
Feb. 2, 2010 (JP) 2010-020905
Feb. 15, 2010 (JP) 2010-029929

(51) Int. Cl. B41J 5/12; B32B 38/00

(52) U.S. Cl. 400/472; 156/242

(57) ABSTRACT

The present invention relates to a thin keypad that includes an elastic sheet that is made of resin or elastomer, and a group of keys including a plurality of keys that are formed from one key sheet through laser-cutting, and that are fixed on the elastic sheet as a laser-cut configuration, wherein the plurality of keys is made of light curing resin with a thickness of 1.0 mm or less, and the narrowest spacing between the keys adjacent each other is equal to or less than 500 μm.

### CROSS REFERENCE

The present application is related to, claims priority from and incorporates by reference Japanese patent application number 2010-001163, filed on Jan. 6, 2010, Japanese patent application number 2010-020905, filed on Feb. 2, 2010, and Japanese patent application number 2010-029929, filed on Feb. 15, 2010. The present application is also related to Japanese patent application number 2008-121792, filed on May 8, 2008.

### TECHNICAL FIELD

The present application relates to a thin keypad assembly (a thin keypad) that can be mounted on an electronic device, especially a small electronic device, and a method for manufacturing the thin keypad assembly.

### RELATED ART

In a recent market for electronic devices, thinner or smaller electronic devices, such as a mobile phone, a mobile computer, and a remote controller for a TV, are strongly desired. Therefore, a keypad that is assembled in the electronic devices is desired to be thinner and have narrower spacing between keys (key spacing). However, when a key is thinner, it is hard to form a concavo-convex shape that is accurately transferred by a mold shape because viscosity of melted resin is high in the case of injection molding that uses thermoplastic resin. As countermeasures for this difficulty, the viscosity can be lowered by increasing the temperature of the melted resin. However, there is a problem in the countermeasures. There is a high possibility to form air bubbles in the molded keypad because air bubbles tend to be formed in the resin. In order to solve the above problem, a method in which light curing resin, which easily causes accurate transfer of the mold shape without increasing temperature, has been well known as disclosed in, for example, Japanese patent application laid-open number 2002-109987. Meanwhile, when the key spacing is narrower, it is hard to arrange a plurality of keys that is divided into individual keys with desired key spacing. As countermeasures for this problem, it has been attempted to manufacture one piece of a keypad in which a plurality of keys is continuously connected.

However, when each of the keys is continuously connected, an operator (user) feels heavier key pressing than the case in which keys are divided into individual keys. Furthermore, when one key, which is continuously connected to other keys, is pressed, a plurality of keys adjacent to the pressed key tends to be also pressed in conjunction with the pressed key. Therefore, it is preferred to lower the risk of pressing several keys at a time through lightening the key pressing feeling by dividing keys into individual keys. A punch out method in which a cutting point (blade) is applied to peripheral areas of each key is frequently used as a method for dividing keys into individual keys from a keypad that was formed by an integral molding. However, when key spacing is equal to or less than 1.0 mm, the key spacing may be smaller than a width of the cutting point (blade). As a result, it is hard to accurately punch out keys by the cutting point (blade) without damaging the keys.

### SUMMARY

With consideration of the situation described above, the present application provides a thin keypad with narrow key spacing. One embodiment of a keypad according to the present application is as follows: a keypad includes an elastic sheet that is made of resin or elastomer; and a group of keys (hereinafter referred to as a key or keys) including a plurality of keys that is two or more, that are formed from one key sheet through laser-cutting, and that are fixed on the elastic sheet as a laser-cut configuration, wherein the plurality of keys is made of light curing resin with a thickness of 1.0 mm or less, and the narrowest spacing between the keys adjacent each other is equal to or less than 500 μm.

Another embodiment of a thin keypad according to the present application is as follows: a flange that is formed on a surface, which faces the elastic sheet, of the plurality of keys, and a thickness of the flange may be equal to or less than 100 μm.

Yet another embodiment of a thin keypad according to the present application is as follows: a film may be formed on a rear surface of the plurality of keys.

Yet another embodiment of a thin keypad according to the present application is as follows: a keypad further includes a frame that is provided at circumference of the group of keys, wherein the plurality of keys includes a proximity key that is provided adjacent and opposite to a side of the frame, and at least one of the sides of the frame and at least one of the proximity keys may be connected by at least one connection part per the proximity key.

Yet another embodiment of a thin keypad according to the present application is as follows: at least one of the sides of the frame and all the proximity keys that are provided adjacent to the side may be connected by at least two connection parts per the proximity key.

Yet another embodiment of a thin keypad according to the present application is as follows: at least one of the sides of the frame and a central proximity key that is one of the proximity keys and that is located at the approximate center of the side in a longitudinal direction may be connected by at least one connection part per the central proximity key.

Yet another embodiment of a thin keypad according to the present application is as follows: at least one of the sides of the frame and another proximity key adjacent to the central proximity key may be connected by at least one connection part per the another proximity key.

Yet another embodiment of a thin keypad according to the present application is as follows: a decoration layer that includes at least one of thermosetting resin and light curing resin and an adhesion layer that is made of resin that can soften or melt by application of heat or pressure are sequentially provided on a rear side of a plurality of keys; and the plurality of keys may be bonded to the elastic sheet through the adhesion layer.

Yet another embodiment of a thin keypad according to the present application is as follows: a decoration layer that includes at least one of thermosetting resin and light curing resin is provided on a front side of a plurality of keys; an adhesion layer that is made of resin that can soften or melt by application of heat or pressure is provided on a rear side of the plurality of keys; and the plurality of keys may be bonded to the elastic sheet through the adhesion layer.

An embodiment of a method for manufacturing a thin keypad according to the present application includes the following operations: a resin supplying operation in which a light curing resin composition, which is in a non-cured state, is supplied into a mold; a curing operation in which the light curing resin is cured by applying light to form a key sheet; a cutting operation in which the key sheet is cut by a laser beam (laser-cutting) to form a group of keys including a plurality of keys; and a fixing operation in which the group of keys is fixed to an elastic sheet that is made of resin or elastomer.

Another embodiment of a method for manufacturing a thin keypad according to the present application includes the following operations: the cutting operation may be performed to prevent a position of the plurality of keys from changing after the cutting operation, and the fixing operation may be performed to fix the group of keys to the elastic sheet with maintaining the as-cut position of the group of keys after the cutting operation.

Yet another embodiment of a method for manufacturing a thin keypad according to the present application includes the following operations: a film providing operation in which a film is provided on a surface of the light curing resin composition, which is in a non-cured state, opposite to the mold may be performed between the resin supplying operation and the curing operation, and a film removing operation in which the film is removed may be performed between the curing operation and the fixing operation.

### BRIEF DESCRIPTION OF THE DRAWINGS

FIG. 1 is a plan view of an electronic device that has a display unit and an operation unit.

FIG. 2 is a perspective view of a thin keypad that is assembled in an electronic device shown in FIG. 1.

FIG. 3 is a sectional view of a thin keypad shown in FIG. 2 including an enlarged part (X1) of the thin keypad.

FIG. 4 is a schematic view of the status for each stage of a manufacturing process of a thin keypad shown in FIG. 2.

FIG. 5 is a schematic view of the status for each stage of a manufacturing process of a thin keypad following FIG. 4.

FIG. 6 is a plan view of another electronic device that has a display unit and an operation unit.

FIG. 7 is a perspective view of a thin keypad that is assembled in an electronic device shown in FIG. 6.

FIG. 8 is a sectional view of a thin keypad shown in FIG. 7 including enlarged parts (X2 and X3) of the thin keypad.

FIG. 9 is a plan view of a front side of a thin keypad shown in FIG. 7 including an enlarged part (X4) of the thin keypad.

FIG. 10 is a plan view of another embodiment of a thin keypad shown in FIG. 9.

FIG. 11 is a plan view of yet another electronic device that has a display unit and an operation unit.

FIG. 12 is a perspective view of a thin keypad that is assembled in an electronic device shown in FIG. 11.

FIG. 13 is a perspective sectional view of a thin keypad shown in FIG. 12 taken along line L1 including an enlarged part (X5) of the thin keypad.

FIG. 14 is an exploded perspective view of a thin keypad shown in FIG. 12.

FIG. 15 is a sectional view of a thin keypad shown in FIG. 12.

FIG. 16 is an enlarged sectional view of a thin keypad shown in FIG. 15.

FIG. 17 is a perspective view of another embodiment of a thin keypad shown in FIG. 12.

FIG. 18 is a perspective sectional view of a thin keypad shown in FIG. 17 taken along line L2 including an enlarged part (X6) of the thin keypad.

FIG. 19 is a schematic view of the status for each stage of a manufacturing process of a thin keypad shown in FIG. 15.

FIG. 20 is a schematic view of the status for each stage of a manufacturing process of a thin keypad following FIG. 19.

FIG. 21 is a sectional view of another embodiment of a thin keypad shown in FIG. 15.

FIG. 22 is flow diagram for showing a manufacturing process of a thin keypad shown in FIG. 21.

### DETAILED DESCRIPTION

Hereinafter, preferred embodiments of a thin keypad and a method for manufacturing the thin keypad will be explained with reference to the drawings.

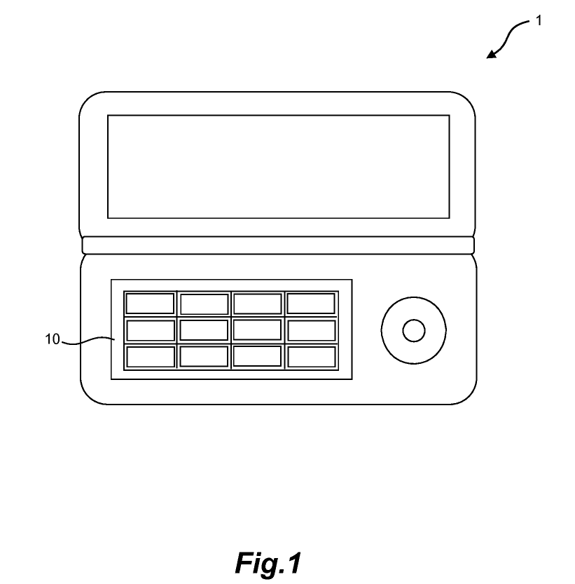

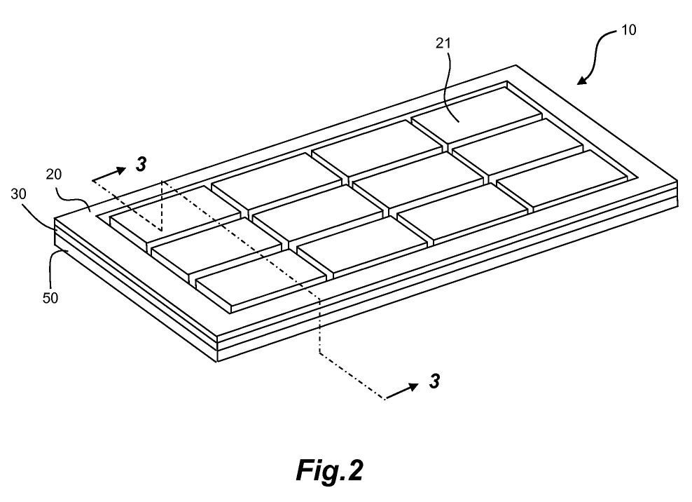

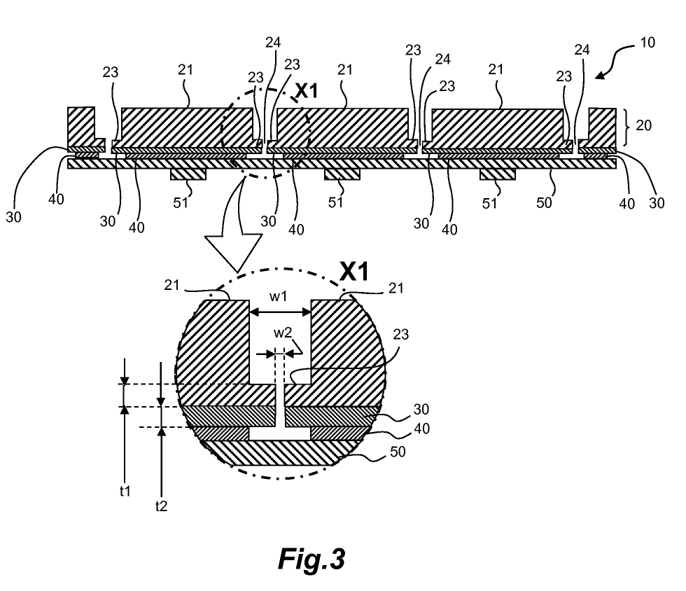

FIG. 1 is a plan view of an electronic device that has a display unit and an operation unit. FIG. 2 is a perspective view of a thin keypad that is assembled in an electronic device shown in FIG. 1. FIG. 3 is a sectional view of a thin keypad shown in FIG. 2 including an enlarged part (X1) of the thin keypad. An electronic device 1 includes a thin keypad 10 in an operation unit. The thin keypad 10 is configured by stacking a key sheet 20, a film 30, and an elastic sheet 50 in order. The key sheet 20 is bonded to the elastic sheet 50 through an adhesion layer 40. The key sheet 20 is configured with a group of keys (hereinafter simply referred to as a plurality of keys, a key, or keys) including a plurality of keys 21 and a frame that surrounds the outside of an aggregated part of the plurality of keys 21. The key 21 includes a flange 23 that has a larger area than an upper part of the key 21 in the side of the elastic sheet 50. It is preferred that a thickness of the key 21 is in a range of 0.2-1.0 mm, and more preferably in a range of 300-600 μm. It is preferred that a thickness of the flange 23 (t1) is in a range of 10-100 μm, and more preferably in a range of 20-50 μm.

The key sheet 20 is preferably made of light curing resin. For example, ultraviolet curing resin can be used as light curing resin. Examples of ultraviolet curing resin are as follows: acrylate-based resin, such as urethane-based acrylate or urethane-based meta-acrylate that is made of, for example, polyester-based, polyether-based, polycarbonate (PC)-based, or aliphatic-based. Note that the light curing resin is not limited to the ultraviolet curing resin, and, for example, may be visible light curing resin or electron beam curing resin. In this embodiment, as discussed later, the key sheet 20 is formed through curing an ultraviolet curing resin composition, which is in a non-cured state, by irradiating ultraviolet (UV) light to the ultraviolet curing resin composition, which is in a non-cured state, for a certain amount of irradiation by using a high-pressure mercury lamp. A photopolymerization initiator is used for curing the ultraviolet curing resin composition. Examples of photopolymerization initiator are as follows: benzophenone-based, benzoin-ether-based, acetophenone-based, and thioxanthene-based photopolymerization initiators. It is preferred to select the photopolymerization initiator depending on the wavelength range of irradiating ultraviolet light and main component of resin. As a combination of main component of resin and photopolymerization initiator, it is preferred to use a combination of urethane-based acrylate resin, which is superior in shape adaptability and flexibility and has excellent light resistance, adhesion property, chemical resistance, and toughness, and 1-hydroxy-cyclohexyl-phenyl-ketone.

The film 30 that adheres to the key 21 has nearly the same area as the flange 23. It is preferred that a thickness (t2) of the film 30 is in a range of 20-100 μm, and more preferably in a range of 30-70 μm. The film 30 may be made of either thermosetting resin or thermoplastic resin, and can preferably be made of polyethylene terephthalate (PET) resin. The film 30 is not an essential member of the thin keypad 10 and may not be used. The adhesion layer 40 is preferably a layer that is made by curing adhesive material or that is configured with a double-stick tape. An area of the adhesion layer 40 is preferably the same or less than an area of the flange 23. The elastic sheet 50 is made of resin or elastomer, and is preferably made of urethane elastomer. It is preferred that a thickness of the elastic sheet 50 can be, for example, in a range of 30-500 μm, and more preferably in a range of 50-200 μm. The elastic sheet 50 includes a plunger 51, which projects toward a direction opposite to the adhesion layer 40, on the rear side of the elastic sheet 50 (side opposite to the adhesion layer 40) and at a lower location from the key 21. A dome-shaped switch (not shown) as an example is provided at the rear side of the plunger 51. When the key 21 is pushed down, the plunger 51 pushes the dome-shaped switch down. As a result, the dome-shaped switch is turned “on.” In this embodiment, the elastic sheet 50 functions as a plunger sheet for switch input.

As shown in an enlarged view in FIG. 3, a width (w1) that is located upper than the flange 23 between adjacent keys 21 is preferably formed at the time of molding. The “w1” is wider than a width (w2) as a gap between the flanges 23. It is preferred that the “w1” is in a range of 200-1000 μm, and more preferably in a range of 400-800 μm. When the “w1” is equal to or more than 200 μM, it is easy to form by molding; and laser-cutting is easily performed at a portion between the flanges 23 after the molding. Similarly, when the “w1” is equal to or less than 1000 μm, desires for narrower spacing between keys 21 (key spacing) and a smaller electronic device 1 as a result of the narrower key spacing are realized. In other words, in order to pursue both ease of cutting a portion between the adjacent keys 21 by a laser beam and making the smaller electronic device 1, it is preferred that the “w1” is set within the range discussed above. In this embodiment, the “w2” is the narrowest portion among gaps between the adjacent keys 21. The “w2” is narrower than the “w1”; and it is preferred that the “w2” is in a range of 10-500 μm, and more preferably in a range of 20-150 μm. When the “w2” is equal to or more than 10 μm, it is easy to adjust a line width of a laser beam. In addition, the following risk can be lowered: the keys 21 contact each other due to dislocation and so on of the keys 21 after cutting. Similarly, when the “w2” is equal to or less than 500 μm, the desire for narrower spacing between keys 21 (key spacing) and the smaller electronic device 1 as a result of the narrower key spacing are realized. In other words, in order to pursue both reducing contact probability of the keys 21 and making the smaller electronic device 1, it is preferred that the “w2” is set within the range discussed above. A decoration layer may be formed at a position, which is just below the keys 21, in the film 30 or the elastic sheet 50. The decoration layer is formed by painting an ink containing resin or inorganic pigment, or by performing metal evaporation.

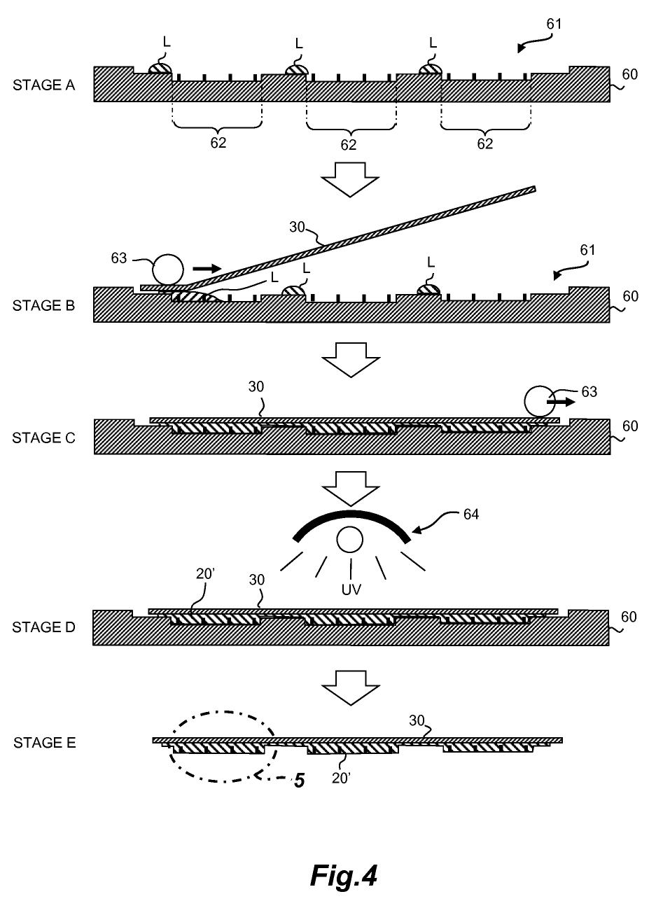

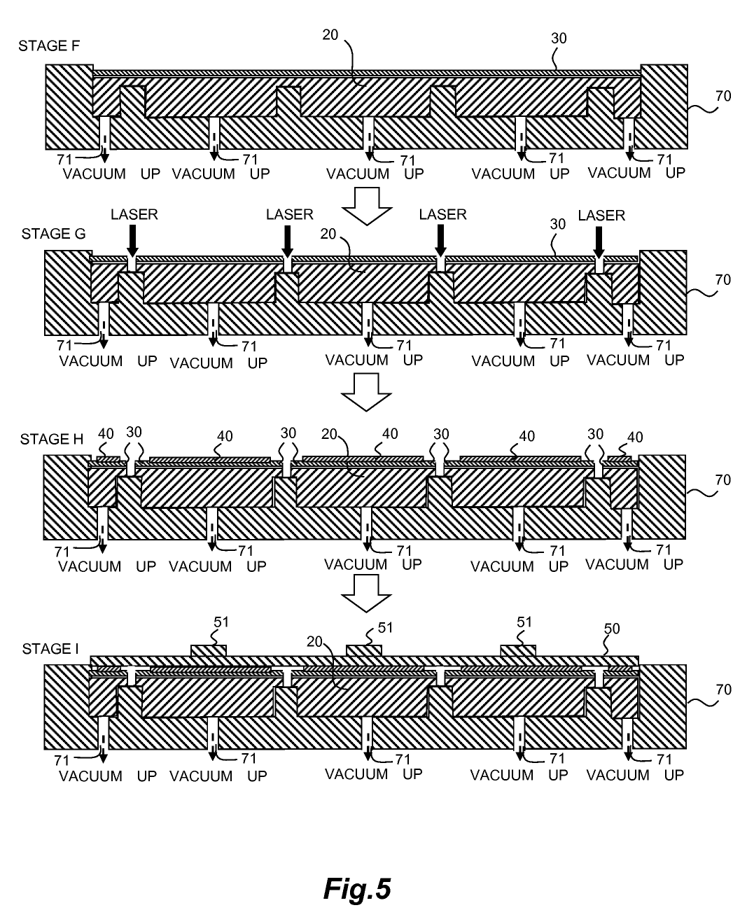

FIGS. 4 and 5 are schematic views of the status for each stage of a manufacturing process of a thin keypad shown in FIG. 2.

Stage A

First of all, a mold 60 is prepared for forming the key sheet 20. A light curing resin composition L, which is in a non-cured state, is supplied into the mold 60 (resin supplying operation). Specifically, as shown in FIG. 4, the light curing resin composition L, which is in a non-cured state, is supplied by a dispenser or the like (not shown) at outer edges of a plurality of concave portions 62 that are formed inside a concave portion 61 of the mold 60 and at leading sides that are covered by the film 30.

Stages B and C

Next, the film 30 is adhered to a surface of the light curing resin composition L, which is in a non-cured state. Specifically, as shown in FIG. 4, after a roller 63 contacts the film 30 from above, the roller 63 is moved in a direction of arrow (right direction in FIG. 4). The roller 63 is rotationally moved at a height that is approximately the same height as an outermost circumference surface of the mold 60. A thickness (t1) of the flange 23 shown in FIG. 3 can be adjusted by a gap between the film 30 that is just below the roller 63 and a bottom surface of the concave portion 61. The film 30 is mainly used for a purpose to smooth a lower side of the key sheet 20 after curing, and for a purpose to escape air bubbles in the concave portions 62 while filling the light curing resin composition L, which is in a non-cured state, inside the concave portions 62 at the time of covering the film 30. When the roller 63 is moved, the light curing resin composition L, which is in a non-cured state, is sequentially filled in the concave portions 62 in a moving direction of the roller 63. At the same time, the air bubbles inside the concave portions 62 are moved in the moving direction of the roller 63 and are emitted outside. The roller 63 stops moving at a position in which adhesion of the film 30 to a certain number of the concave portions 62 is completed.

Stage D

The light curing resin composition L is cured by irradiating ultraviolet light toward the light curing resin composition L, which is in a non-cured state, in the mold 60 from above the film 30 (curing operation). Specifically, the light curing resin composition L is cured by irradiating ultraviolet light from above the film 30 by using a lamp 64, such as a metal halide lamp.

Stage E

Next, a molded member 20′ with the film 30 is taken from the mold 60. Then, the molded member 20′ is cut in a size in accordance with an area of a bottom surface of the key sheet 20 as a unit of a portion surrounded by a dashed-dotted line in the stage E.

Stage F

Next, the key sheet 20 with the film 30 that is cut from the molded member 20′ is set inside a jig 70 for laser-cutting. The jig 70 preferably includes a plurality of holes 71 for externally suctioning the key sheet 20 at positions corresponding to each key 21 in order to fix the keys 21 to the jig 70. The key sheet 20 is cut by a laser beam while externally suctioning the key sheet 20 from outside the jig 70 through the plurality of holes 71. The jig 70 preferably includes a concave portion to fix the keys 21.

Stage G

Next, the key sheet 20 is cut into a plurality of keys 21 by irradiating a laser beam to the periphery of each key 21 (cutting operation). At this time, because a line width of the laser beam is narrower than a gap between the keys 21, the flange 23 is formed at the periphery of each key 21. As a laser irradiation device, “LP-430U” that is manufactured by Panasonic Electric Works SUNX Corporation can be preferably used.

Stages H and I

Next, the adhesion layer 40 is formed on the film 30. Lastly, the elastic sheet 50 with the plunger 51 is fixed to each key 21 through the adhesion layer 40 (fixing operation). During the above manufacturing operations, a film providing operation in which the film 30 is provided on a side opposite to the mold 60 that includes a light curing resin composition, which is in a non-cured state, may be performed between the resin supplying operation and the curing operation; and a film removing operation in which the film 30 is removed may be performed between the curing operation and the fixing operation. When a decoration layer is formed at the film 30 or the elastic sheet 50, it is preferred that an operation for forming the decoration layer is performed before the fixing operation.

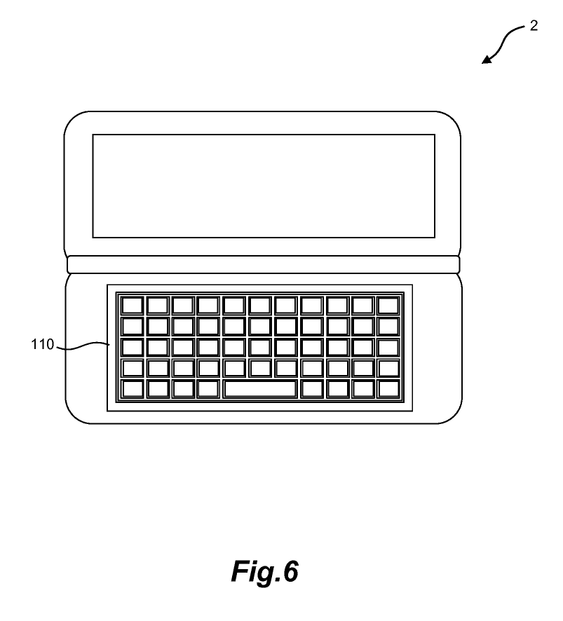

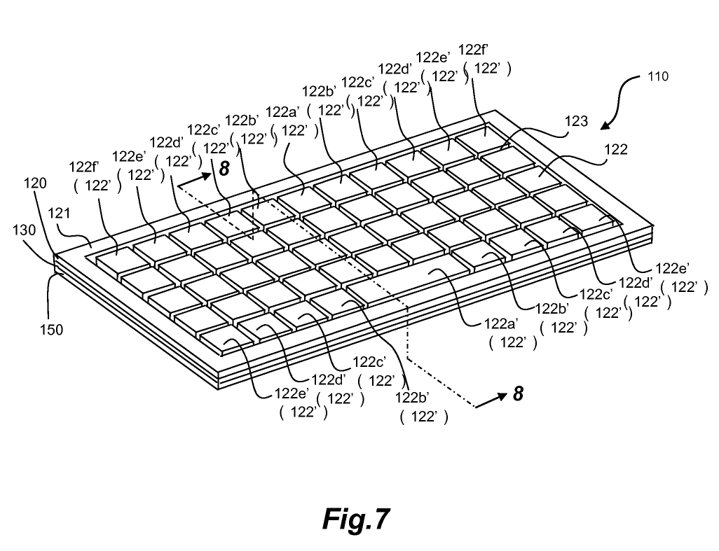

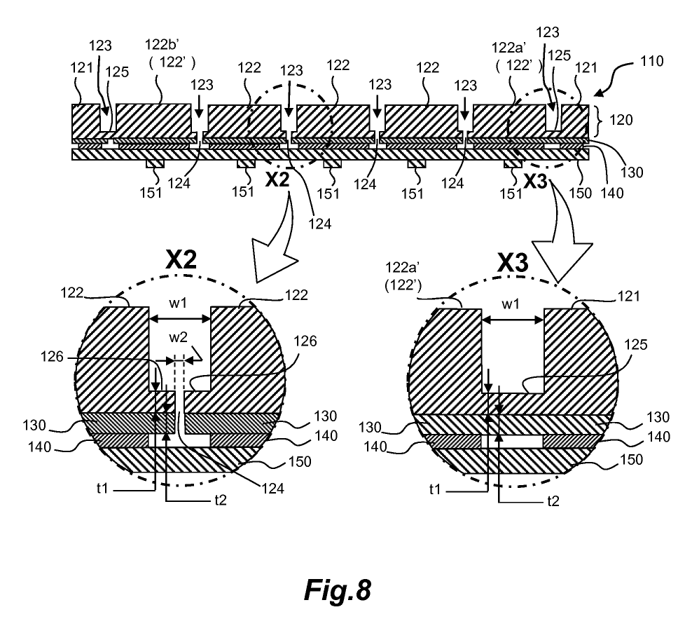

FIG. 6 is a plan view of another electronic device that has a display unit and an operation unit. FIG. 7 is a perspective view of a thin keypad that is assembled in an electronic device shown in FIG. 6. FIG. 8 is a sectional view of a thin keypad shown in FIG. 7 including enlarged parts (X2 and X3) of the thin keypad. An electronic device 2 includes a thin keypad 110 in an operation unit. The thin keypad 110 has a similar configuration as the thin keypad 10 discussed above. The thin keypad 110 is configured by stacking a key sheet 120, a film 130, and an elastic sheet 150 in order. The key sheet 120 is bonded to the elastic sheet 150 through an adhesion layer 140. The key sheet 120 is configured with a plurality of keys 122 and a frame 121 that surrounds the outside of an aggregated part of the plurality of keys 122. The elastic sheet 150 includes a plunger 151, which projects from the rear side of the elastic sheet 150, at a position just below each key 122 on the rear side of the elastic sheet 150. The plunger 151 is preferably made of a material with hardness that is equal to or more than that of the elastic sheet 150. The key sheet 120 includes more keys 122 than the key sheet 20 discussed above. The keys 122 are arranged in five rows in a widthwise direction. The keys 122 in four rows from an edge within the five rows are in a nearly square shape as a planar shape with planar view, and are arranged in eleven columns in a lengthwise direction. An elongated key 122 that is elongate in the lengthwise direction with planar view is located at nearly center of remaining one row provided at the edge within the five rows in the lengthwise direction of the key sheet 120. The keys 122, which have the same shape as the above mentioned keys 122 that has the nearly square shape as the planar shape, are arranged at other portions of the remaining one row. A groove 123 that is sagged toward the film 130 is formed at the periphery (including a portion between the frame 121 and the keys 122) of the keys 122. In other words, the key sheet 120 has a configuration that is divided into the frame 121 and each of the keys 122 by the groove 123. In a subsequent explanation, for convenience of explanation, the keys 122 that are located with the closest distance to the frame 121 along both long sides of the key sheet 120 in the lengthwise direction are referred to as “proximity key(s)” 122′; and the proximity key(s) 122′ that is located at nearly center of the proximity keys 122′ in the lengthwise direction is referred to as “central proximity key(s)” 122a′. When the number of the proximity keys 122′ is an even number, two of the proximity keys 122′ located at the center are referred to as central proximity keys 122a′. The proximity keys 122′ that are located close to one long side within two long sides of the frame 121 are configured with an elongated central proximity key 122a′ that is elongate in the lengthwise direction of the long side, proximity keys 122b′ that are located both outside of the elongated central proximity key 122a′ in the lengthwise direction, and proximity keys 122e′, 122d′, and 122e′ that are located further both outside of the proximity keys 122b′ in order. Similarly, the proximity keys 122′ that are located close to another long side are configured with a central proximity key 122a′, proximity keys 122b′ that are located both outside of the central proximity key 122a′ in the lengthwise direction, and proximity keys 122c′, 122d′, 122e′, and 122f that are located further both outside of the proximity keys 122b′ in order.

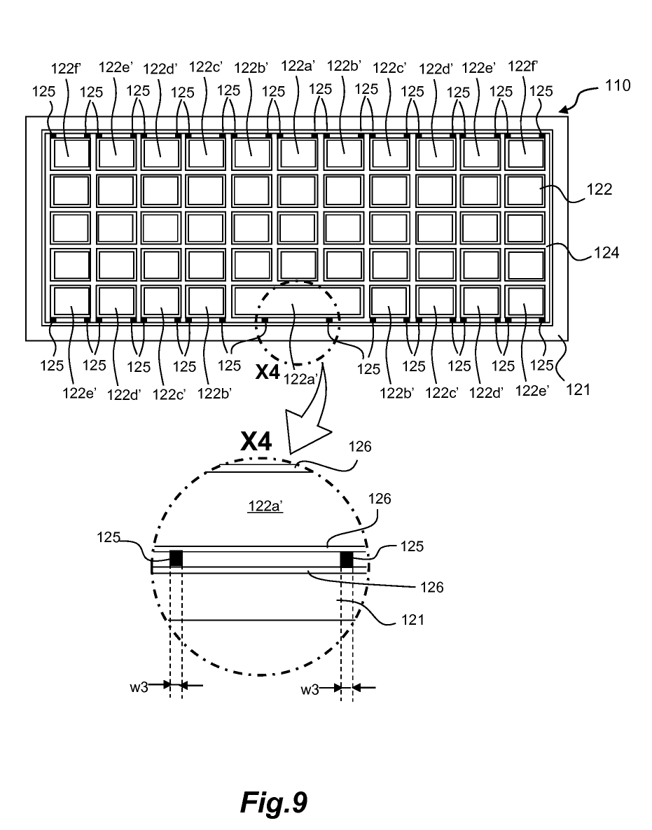

As shown in X2 in FIG. 8, the keys 122 include flanges 126 that have a larger area than an upper part of the key 122 in the side of the elastic sheet 150. Peripheries of the keys 122 along with the film 130 except the proximity keys 122′ are completely divided each other by a gap 124. On the other hand, as shown in X3 in FIG. 8, the proximity key 122′ is connected to a long side of the frame 121 through a connection part 125 and is not completely divided (as will hereinafter be described in detail with reference to FIG. 9). Connection between the proximity key 122′ and the long side of the frame 121 prevents a nearly center part of the long side of the frame 121 in the lengthwise direction from deforming toward inside. As a result, uniformity among the keys 122 is realized; and thus the keys are easily depressed. When the central proximity key 122a′ is connected to the long side of the frame 121 through the connection part 125, the effects discussed above become conspicuous. The key sheet 120 is preferably made of light curing resin in the same manner as the key sheet 20 discussed above. A decoration layer may be formed at a position, which is just below each of the keys 122, in the film 130 or the elastic sheet 150 in the same manner as the thin keypad 10 discussed above. A preferred thickness of the key sheet 120, i.e. the key 122, a preferred thickness (t1) of the flange 126, a preferred thickness (t2) of the film 130, a preferred width (w1) of the groove 123, and a preferred width (w2) of the gap 124 are the same as the thickness of the aforementioned key sheet 20, i.e. the key 21, the thickness (t1) of the aforementioned flange 23, the thickness (t2) of the aforementioned film 30, the width (w1) that is located upper than the flange 23 between adjacent keys 21, and the width (w2) of a gap 24 between the flanges 23, respectively. The adhesion layer 140 and the elastic sheet 150 are also the same as the adhesion layer 40 and the elastic sheet 50, respectively. The film 130 is not an essential member of the thin keypad 110 and may not be used. During the above manufacturing operations for the thin keypad 110, a film providing operation may be performed between the resin supplying operation and the curing operation; and a film removing operation may be performed between the curing operation and the fixing operation in the same manner as the aforementioned manufacturing operations for the thin keypad 110. Because some of the keys 122 and the frame 121 are connected in the thin keypad 110 shown in FIG. 7, the fixing operation does not mean that each individual key 122 is bonded to the elastic sheet 150, but does mean that the key sheet 120 is bonded to the elastic sheet 150.

FIG. 9 is a plan view of a front side of a thin keypad shown in FIG. 7 including an enlarged part (X4) of the thin keypad. Each proximity key 122′ is connected to the long side of the adjacent frame 121 through the connection part 125. The connection part 125 is a remaining part that is not cut since a portion between the long side of the frame 121 and the proximity key 122′ is not completely divided. Each proximity key 122′ is connected to the long side of the frame 121 through two of the connection parts 125. The elongated central proximity key 122a′ is connected to the long side of the frame 121 through two of the connection parts 125 at positions that nearly divide the elongated central proximity key 122a′ into three in the lengthwise direction. The other proximity keys 122′ except the elongated central proximity key 122a′ are connected to the long side of the frame 121 through two of the connection parts 125 per each proximity key 122′ at both ends of a side of the proximity keys 122′ that face the long side of the frame 121. The proximity key 122′ may be connected to the long side of the frame 121 through one, or three or more of the connection parts 125. A width (w3) of the connection part 125 can be set as several kinds of values in accordance with the length of the proximity key 122′. However, a total width of the widths (w3) of one, or two or more of the connection parts 125 is preferably set as a certain value that is not exceed 50% against a length of the proximity keys 122′ including the connection parts 125 (length of the long side of the frame 121). Because the total width is equal to or less than 50%, it can be easy to press the proximity key 122′ down even though a thickness of the connection part 125 (same as the thickness (t1) of the flange 126) is large.

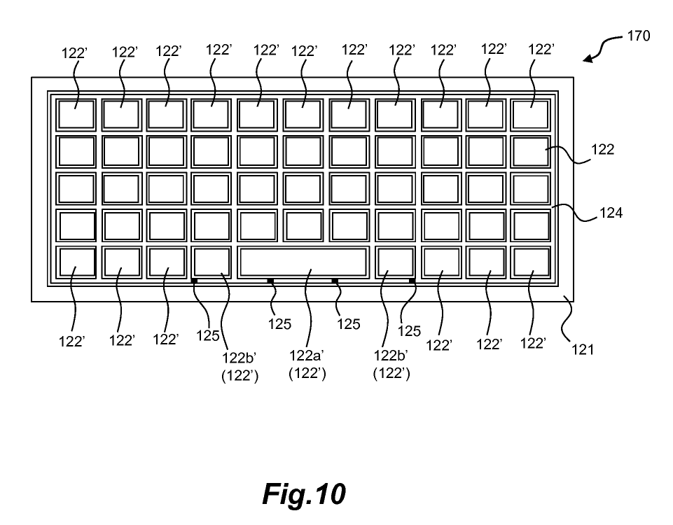

FIG. 10 is a plan view of another embodiment of a thin keypad shown in FIG. 9. A thin keypad 170 shown in FIG. 10 includes the connection part 125 at just a side in which the elongated central proximity key 122a′ is located. The connection parts 125 connect between the long side of the frame 121, and the elongated central proximity key 122a′ and adjacent proximity keys 122b′ that are located at both sides of the elongated central proximity key 122a′ in the lengthwise direction. These connection parts 125 that are formed in the above described manner can reduce deformation of the thin keypad 170. Further, the long side of the frame 121 opposite to the side in which the elongated central proximity key 122a′ is located can be connected to the proximity key 122′ that is adjacent to the long side through the connection part 125. One, or two or more of the proximity keys 122′ can be connected to at least one long side of the frame 121 through one, or two or more of the connection parts 125 per the proximity key 122′. In this case, it is preferred that the central proximity key 122a′ is connected to the long side of the frame 121 through the connection part 125.

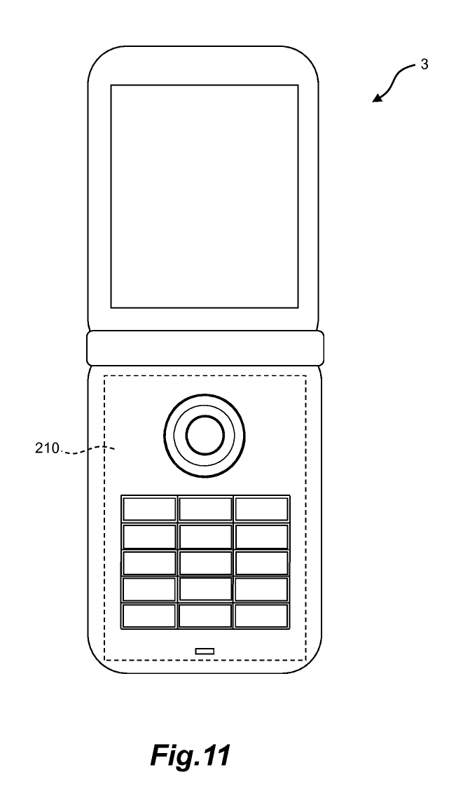

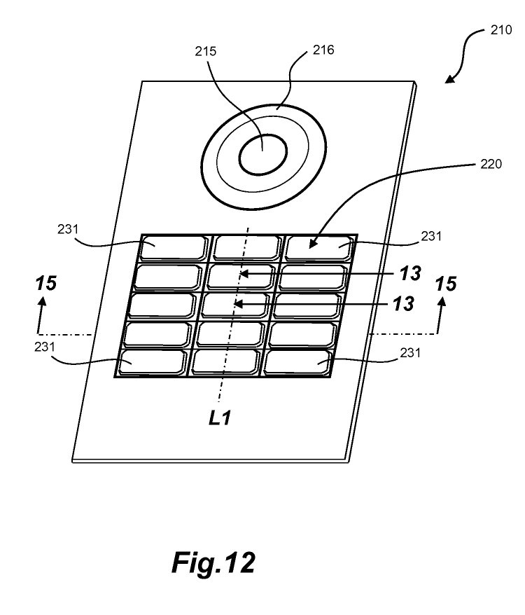

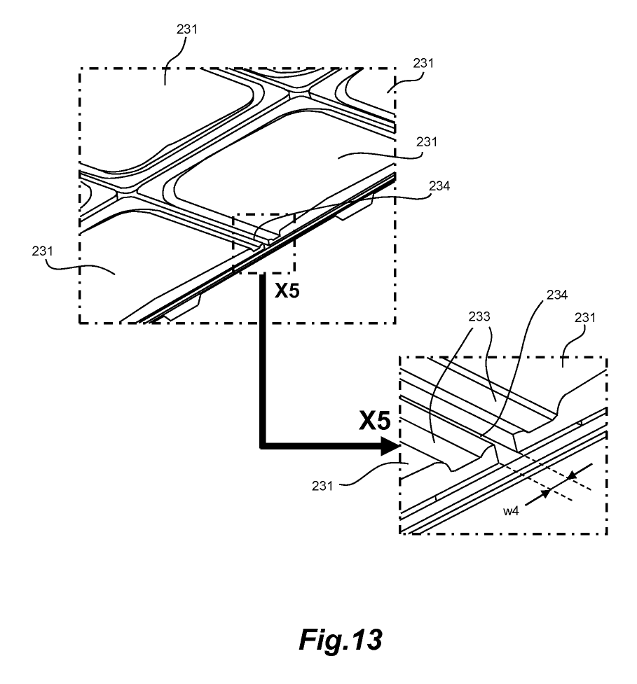

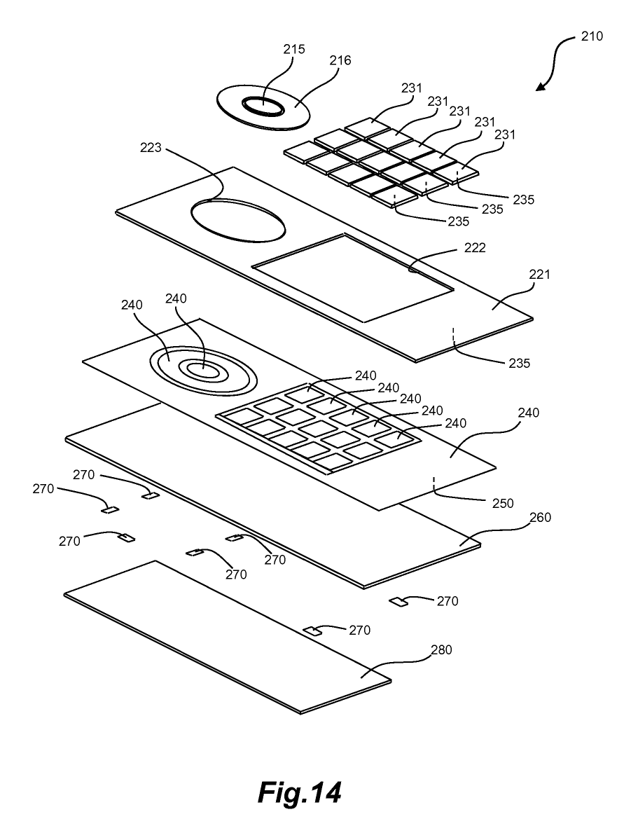

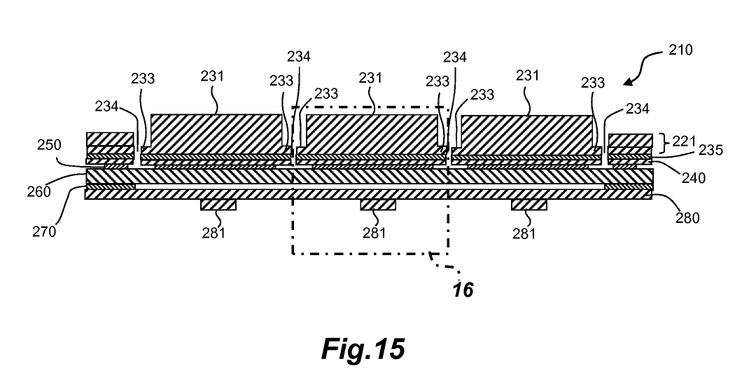

FIG. 11 is a plan view of yet another electronic device that has a display unit and an operation unit. FIG. 12 is a perspective view of a thin keypad that is assembled in an electronic device shown in FIG. 11. FIG. 13 is a perspective sectional view of a thin keypad shown in FIG. 12 taken along line L1 including an enlarged part (X5) of the thin keypad. FIG. 14 is an exploded perspective view of a thin keypad shown in FIG. 12. FIG. 15 is a sectional view of a thin keypad shown in FIG. 12. An electronic device 3 includes a thin keypad 210 in an operation unit. As shown in FIG. 12, the thin keypad 210 includes an enter key 215 that is located at an upper part on a surface of a front side of the thin keypad 210 and that can be pressed down toward a rear side, and a multidirectional key 216 in an annular shape that surrounds the enter key 215 and that can be pressed down toward the rear side in a multidirectional manner. The thin keypad 210 also includes a key aggregated part 220 in which fifteen keys 231 are aggregated on the surface of the front side of the thin keypad 210 below the multidirectional key 216. The thin keypad 210 includes a panel 221 in which a quadrilateral through-hole 222 and a circular through-hole 223 are formed. The key aggregated part 220 is located at the through-hole 222. The enter key 215 and the multidirectional key 216 are located at the through-hole 223. Each key 231 preferably includes a flange 233 at its periphery. It is preferred that a thickness of the key 231 is in a range of 0.2-1.0 mm, and more preferably in a range of 300-600 μm. It is preferred that a thickness of the flange 233 is in a range of 10-100 μm, and more preferably in a range of 20-50 μm. A width (w4) of a gap 234 between adjacent keys 231, i.e. a distance between the flanges 233 of adjacent keys 231, is preferably in a range of 10-500 μm. In this embodiment, the “w4” is 20 μm. As shown in FIGS. 14 and 15, the thin keypad 210 is configured by stacking the following members in order on each rear side of each key 231, the enter key 215, and the multidirectional key 216: a film 235, a decoration layer 240, an adhesion layer 250, an elastic sheet 260, an adhesion layer 270, and a plunger sheet 280. A stacking configuration on the rear side of the panel 221 is the same as each key 231.

The key 231, the enter key 215, the multidirectional key 216, and the panel 221 are preferably made of light curing resin. Ultraviolet curing resin can be used as an example of light curing resin. The key 231, the enter key 215, the multidirectional key 216, and that panel 221 are preferably formed by cutting out from one sheet of light curing resin. In the thin keypad 210, the panel 221 is not connected to the key 231. However, the key 231 that is the closest key to the panel 221 may be connected to the panel 221 through a connection part that is similar to the connection part 125 shown in FIG. 9. The film 235 can be made of either of the following materials: thermosetting resin, thermoplastic resin, thermoplastic elastomer, and thermosetting elastomer, and is preferably made of PET, urethane elastomer, or silicone elastomer. The film 235 is not an essential member of the thin keypad 210 and may not be used. During the above manufacturing operations for the thin keypad 210, a film providing operation may be performed between the resin supplying operation and the curing operation; and a film removing operation may be performed between the curing operation and the fixing operation in the same manner as the aforementioned manufacturing operations for the thin keypad 110. The decoration layer 240 is configured with one or a plurality of layers including at least one of thermosetting resin and light curing resin, and is preferably made by printing. Because at least one of thermosetting resin and light curing resin is contained in the decoration layer 240, a pressing mark seldom occurs when the key 231 and the elastic sheet 260 are pressed. Examples of the printing are as follows: an inkjet printing method, an offset printing method, a gravure printing method, a screen printing method, and a coat printing method. Specifically, when polychrome or gradation expression is performed, the screen printing method, the offset printing method, or the gravure printing method can be preferably used. The adhesion layer 250 is made of resin that can soften or melt by application of heat or pressure, and is preferably formed by a wide variety of printing methods in the same manner as the decoration layer 240. Since the adhesion layer 250 exists between the key 231 and the elastic sheet 260, high-strength bonding and further thinning of the thin keypad 210 can be obtained compared with an existing double-stick tape or the like. Specifically, when the adhesion layer 250 is formed on an entire rear surface of the key 231, bonding strength between the key 231 and the elastic sheet 260 increases. The elastic sheet 260 is made of resin or elastomer, and is preferably made of urethane elastomer. The adhesion layer 270 is preferably a layer that is made by curing adhesive material or that is configured with a double-stick tape. The adhesion layer 270 can be formed on an entire area or a part of the rear surface of the elastic sheet 260. The plunger sheet 280 is made of resin or elastomer, and is preferably made of urethane elastomer. The plunger sheet 280 includes a plunger 281, which projects toward a rear side, on the rear side of the plunger sheet 280 and at a position just below each of the keys 231. The plunger 281 is preferably made of a material with hardness that is equal to or more than that of the plunger sheet 280.

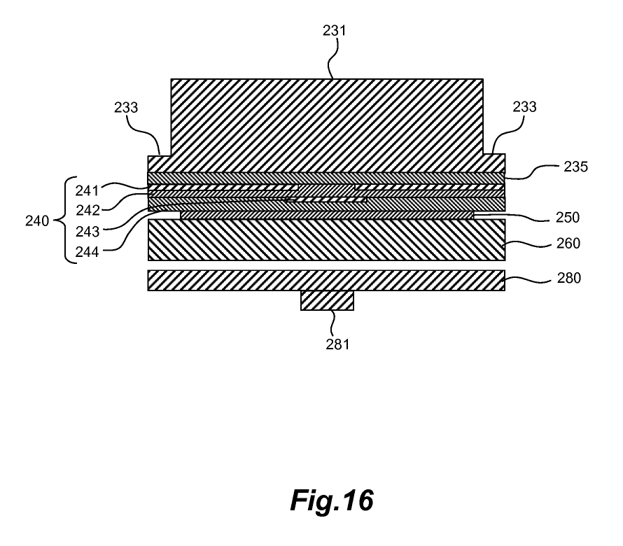

FIG. 16 is an enlarged sectional view of a thin keypad shown in FIG. 15. In this embodiment, the decoration layer 240 is configured with four layers, a first decoration layer 241, a second decoration layer 242, a third decoration layer 243, and a fourth decoration layer 244. The decoration layer 240 may be made of one layer, two to three layers, or five or more layers. The first decoration layer 241 is preferably a layer that is formed by black ink containing thermoplastic resin. When light is transmitted in a numeric shape or in a letter shape from a rear side to a front side of the key 231, it is preferred that the first decoration layer 241 is coated on an area other than areas representing to the numbers or the letters. The second decoration layer 242 is a supplemental strengthening layer to prevent the first decoration layer 241 from flowing, and is preferably a layer that is formed by clear and colorless ink containing thermosetting resin or light curing resin. Because the first decoration layer 241 exists between the film 235 and the second decoration layer 242 that is made of thermosetting resin or light curing resin, flowing of the first decoration layer 241 can be prevented when the key 231 is adhered to the elastic sheet 260 by applying one of heat or pressure through the adhesion layer 250. The third decoration layer 243 is provided to color the areas corresponding to the numbers or the letters of each of the keys 231, and covers the areas in which the first decoration layer 241 does not exist. The third decoration layer 243 is preferably made of color ink containing thermoplastic resin. Because the third decoration layer 243 is made of ink containing thermoplastic resin, a desired color can be selected among a wide variety of colors. The fourth decoration layer 244 is a shield layer to prevent the third decoration layer 243 from flowing, and is preferably made of white ink containing thermosetting resin or light curing resin. Because the third decoration layer 243 exists between the second decoration layer 242 and the fourth decoration layer 244 that are respectively made of thermosetting resin or light curing resin, flowing of the third decoration layer 243 can be prevented when the key 231 is adhered to the elastic sheet 260 by applying one of heat or pressure through the adhesion layer 250.

For example, the following ink can be used to form the first decoration layer 241: mirror effect ink No. 3 (product name), SG740 (product name), and CAV Meiban Black (product name) that are manufactured by Seiko Advance Ltd. For example, the following ink can be used to form the second decoration layer 242 or the fourth decoration layer 244: SG429B (product name) that is urethane-based two-part reaction-curable type thermosetting ink manufactured by Seiko Advance Ltd., #1000 clear (product name) that is epoxy-based two-part reaction-curable type thermosetting ink manufactured by Seiko Advance Ltd., and MIB white (product name) that is urethane-based two-part reaction-curable type thermosetting ink manufactured by Teikoku Printing Inks Mfg. Co., Ltd. For example, the following ink can be used to form the third decoration layer 243: CAV Meiban (product name) that is thermoplastic ink manufactured by Seiko Advance Ltd.

The adhesion layer 250 is preferably formed from a hot-melt tape or hot-melt ink. When the hot-melt tape is used, for example, the hot-melt tape that is cut in the shape of the key 231 is provided between the key 231 and the elastic sheet 260 so that the key 231 and the elastic sheet 260 is adhered by applying one of heat or pressure. When there is a difficulty to accurately place the hot-melt tape, it is preferred to perform the following: after the hot-melt tape is temporary adhered to one of the key 231 or the elastic sheet 260 in advance, one of heat or pressure is applied. For example, when the adhesion layer 250 is formed from the hot-melt tape, the following tape can be used: AS-11 (product name) manufactured by Nitto Denko Corporation. On the other hand, when the hot-melt ink is used, it is preferred to adjust ink viscosity by adding solvent to a hot-melt adhesive material. It is preferred that after ink is applied to one of the key 231 or the elastic sheet 260, one of heat or pressure is applied. When ink is used to form the adhesion layer 250, a wide variety of printing methods in the same manner as the decoration layer 240 can be used. For example, when the adhesion layer 250 is formed from the hot-melt ink, the following ink can be used: SG 740 clear (product name) manufactured by Seiko Advance Ltd., and AD-HM6 (product name) manufactured by Jujo Chemical Co., Ltd. In this case, it is preferred that 10% of isophorone solvent is added to adjust viscosity.

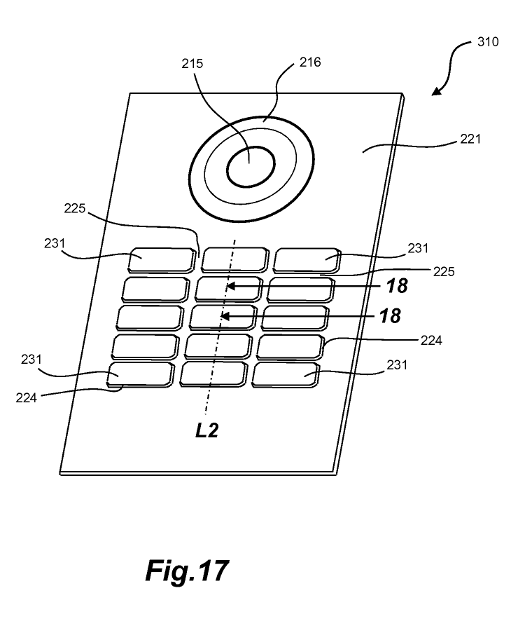

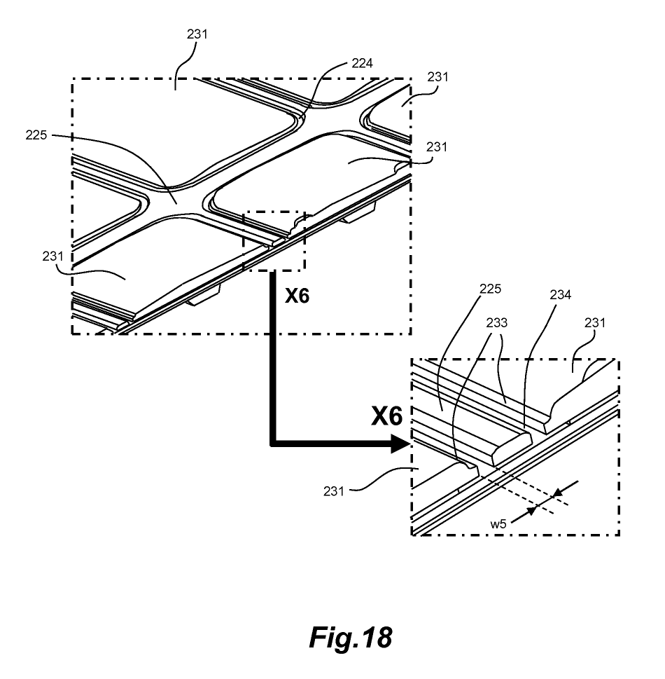

FIG. 17 is a perspective view of another embodiment of a thin keypad shown in FIG. 12. FIG. 18 is a perspective sectional view of a thin keypad shown in FIG. 17 taken along line L2 including an enlarged part (X6) of the thin keypad. A thin keypad 310 is different from the thin keypad 210, and includes a through-hole 224 in which a top of each of the keys 231 individually passes through the panel 221 and a lattice-shaped crosspiece 225 that separates peripheries of each of the keys 231. A gap (w5) between the key 231 and the crosspiece 225 is preferably in a range of 10-30 μm. A width of a gap 234 between the flanges 233 of the keys 231 is preferably in a range of 200-500 μm. Other configurations, structural members and so on of the thin keypad 310 are the same as the thin keypad 210. In the thin keypad 310, the panel 221 is not connected to the key 231. However, the key 231 that is the closest key to the panel 221 may be connected to the panel 221 through a connection part that is similar to the connection part 125 shown in FIG. 9.

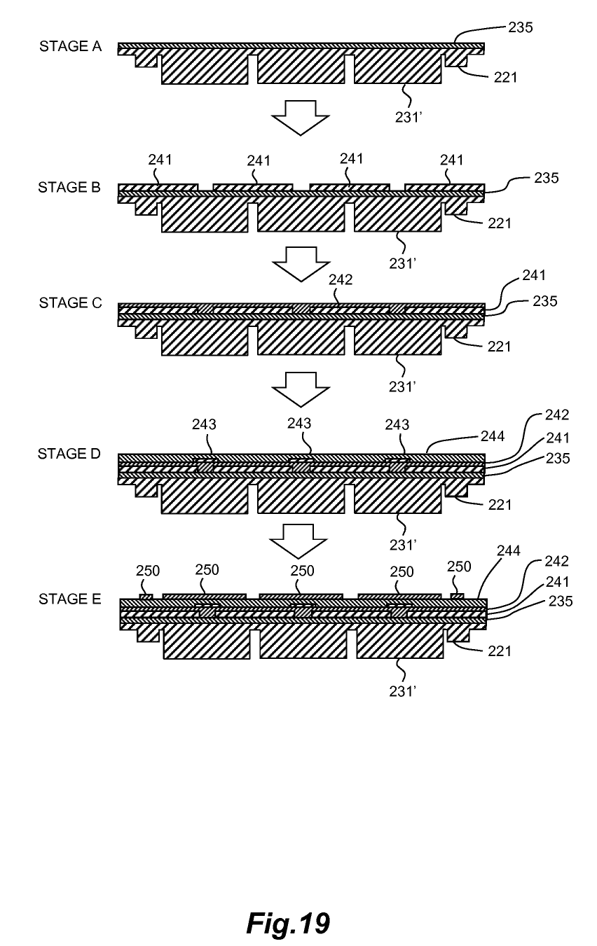

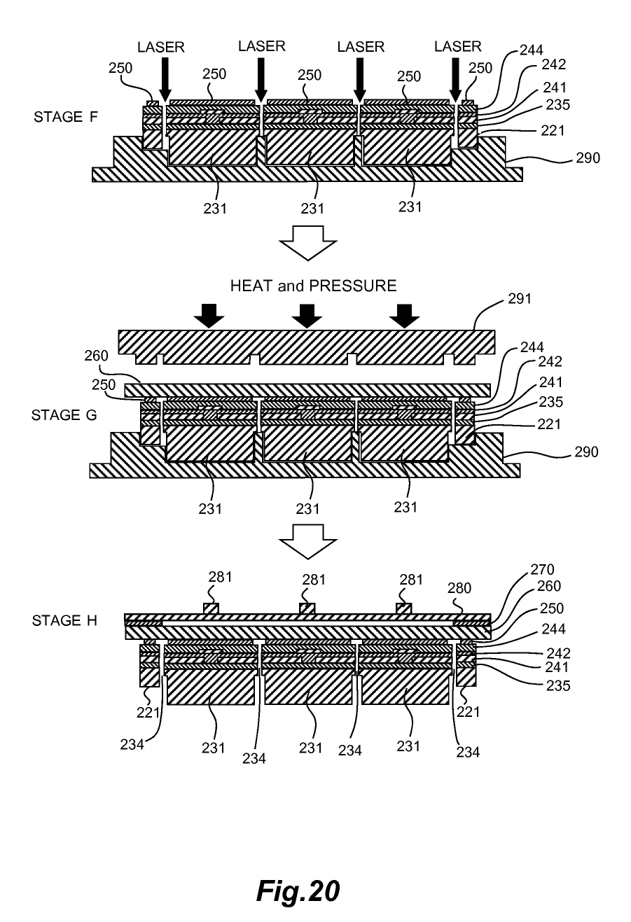

FIGS. 19 and 20 are schematic views of the status for each stage of a manufacturing process of a thin keypad shown in FIG. 15.

Stage A

The panel 221 is formed at the same time as a molded member 231′ (the film 235 is fixed to its rear surface) that is made of light curing resin and that is manufactured through the same manufacturing operations shown in FIG. 4.

Stages B, C and D

The first decoration layer 241 is formed on the rear surface of the film 235 by printing (first decoration layer forming operation). After the first decoration layer 241 is dried at a preferable temperature of 20 to 90° C., more preferably in a range of 50-70° C., the second decoration layer 242 is stacked to cover the first decoration layer 241 on the rear surface of the film 235 by printing (second decoration layer forming operation). After the second decoration layer 242 is dried at a preferable temperature of 20 to 90° C., more preferably in a range of 50-70° C., the third decoration layer 243 is stacked to cover areas in which the first decoration layer 241 does not exist on the rear surface of the second decoration layer 242 by printing (third decoration layer forming operation). After the third decoration layer 243 is dried at a preferable temperature of 30 to 100° C., more preferably in a range of 70-90° C., the fourth decoration layer 244 is stacked to cover the third decoration layer 243 on the rear surface of the second decoration layer 242 by printing (fourth decoration layer forming operation).

Stage E

After the fourth decoration layer 244 is dried at a preferable temperature of 30 to 100° C., more preferably in a range of 70-90° C., the adhesion layer 250 is formed on the rear surface of the fourth decoration layer 244 and at a position just below each of the keys 231 and the panel 221 by printing (adhesion layer forming operation). The adhesion layer 250 is preferably dried at a temperature of 30 to 100° C., more preferably in a range of 70-90° C.

Stage F

Next, after the molded member 231′ on which the decoration layers 241-244 and the adhesion layer 250 are printed is set in a jig 290 for laser-cutting, it is cut into a unit of each key 231 by irradiating a laser beam to peripheries of each key 231 (cutting operation). The cutting operation in STAGE F in which the laser beam is used can be performed right after STAGE A.

Stage G

Next, after the elastic sheet 260 is provided at the rear surface of the adhesion layer 250, a jig 291 for heat stamping is applied with pressure to the rear surface side of the elastic sheet 260 (fixing operation). The heat temperature and pressing time are preferably in ranges of 120-200° C. and 5-60 seconds, and more preferably in ranges of 150-170° C. and 10-30 seconds, respectively.

Stage H

Next, after the adhesion layer 270 that is made of a double-stick tape and so on is adhered to the elastic sheet 260, the plunger sheet 280 with the plunger 281 is fixed thereto.

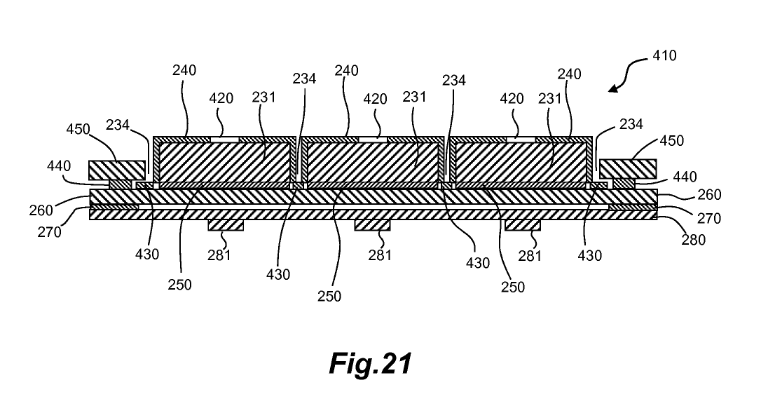

FIG. 21 is a sectional view of another embodiment of a thin keypad shown in FIG. 15. A thin keypad 410 is configured by stacking the following members in order on a rear surface of each key 23: an adhesion layer 250, an elastic sheet 260, an adhesion layer 270, and a plunger sheet 280. In the thin keypad 410, a film does not exist between the key 231 and the adhesion layer 250. However, the film may be provided at the rear surface of the key 231. The thin keypad 410 includes a frame-like panel 450 that is located at the external side of an aggregated area of each key 231. The panel 450 is adhered to the elastic sheet 260 through an adhesion layer 440 that is made of a double-stick tape or the like. A decoration layer 240 is formed on front and side surfaces of each of the keys 231. The decoration layer 240 is a light shielding layer that is preferably formed by printing black or silver color ink. Each of the keys 231 includes areas 420 on which the decoration layer 240 is not formed for numbers and letters on the front surface of the keys 231. The areas 420 are printed by clear and colorless ink or clear and color ink, or are not printed at all. The areas 420 contribute emitting light in shapes of numbers and letters when a light source (LED or the like) is provided at a position in rear or side surface directions of the elastic sheet 260. The elastic sheet 260 preferably includes light shielding layers 430 on its front surface at gap positions between the keys 231 and between the key 231 and the panel 450. Further, when the panel 450 is made of a clear material (for example, polycarbonate, PET, glass), a light shielding layer is preferably formed on the rear surface of the panel 450 by printing. This is because leaking light from the light source toward outside through gaps between the adjacent keys 231 and between the key 231 and the panel 450, and through the panel 450 itself, is reduced. Each structural material and each manufacturing method for the keys 231 and the decoration layer 240 are the same as that of the thin keypad 310. Each structural material for the elastic sheet 260, the adhesion layer 270, and the plunger sheet 280 is also the same as that of the thin keypad 310. The adhesion layer 250 may be configured with only one layer, or a stacking layer with two or more layers. In this embodiment, the elastic sheet 260 is made of thermoplastic urethane elastomer.

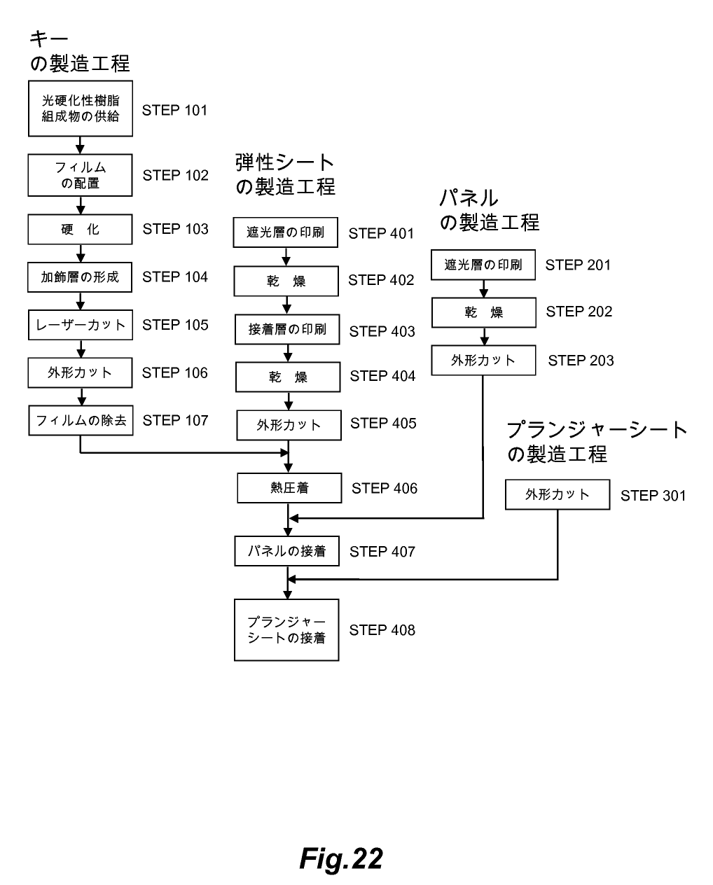

FIG. 22 is flow diagram for showing a manufacturing process of a thin keypad shown in FIG. 21. Manufacturing operations for the thin keypad 410 are preferably broadly-divided into the following operations: a key manufacturing Operation, a panel manufacturing operation, a plunger sheet manufacturing operation, and an elastic sheet manufacturing operation.

[Key Manufacturing Operation]

A light curing resin composition, which is in a non-cured state, is supplied into a mold (STEP 101: resin supplying operation).

Next, a film is provided on a fluid level of the light curing resin composition (STEP 102: film providing operation).

Next, the light curing resin composition is cured by irradiating light from above the film (STEP 103: curing operation)

Next, after a molded member is taken out from the mold, a decoration layer 240 is formed on front and side surfaces of each of the keys 231 (STEP 104: decoration layer forming operation).

Next, the molded member is cut into a unit of each key 231 by irradiating a laser beam to a position between each of the keys 231 (STEP 105: cutting operation).

Next, an outer shape of the molded member is cut (STEP 106).

Next, the film is removed (STEP 107: film removing operation).

[Panel Manufacturing Operation]

A light shielding layer is formed on the rear surface of the panel 450 by printing (STEP 201).

Next, the light shielding layer is dried at a preferable temperature of 30 to 100° C., more preferably in a range of 70-90° C. (STEP 202).

Next, an outer shape of the panel 450 is cut (STEP 203).

[Plunger Sheet Manufacturing Operation]

An outer shape of the plunger sheet 280 on which the plunger 281 is formed at a predetermined position, is cut (STEP 301).

[Elastic Sheet Manufacturing Operation]

The light shielding layer 430 is formed on the elastic sheet 260 by printing (STEP 401).

Next, the light shielding layer 430 is dried at a preferable temperature of 20 to 90° C., more preferably in a range of 50-70° C. (STEP 402).

Next, the adhesion layer 250 is formed on the elastic sheet 260 by printing (STEP 403: adhesion layer forming operation).

Next, the adhesion layer 250 is dried at a preferable temperature of 20 to 90° C., more preferably in a range of 50-70° C. (STEP 404).

Next, an outer shape of the elastic sheet 260 is cut (STEP 405).

Next, after each of the keys 231, which is formed by completing STEP 107, is placed on the adhesion layer 250 of the elastic sheet 260, each of the keys 231 is fixed to the elastic sheet 260 through thermocompression at a preferable temperature of 120-200° C., more preferably in a range of 150-170° C. by applying a jig for heat stamping from above with pressure (STEP 406: fixing operation).

Next, the panel 450, which is formed by completing STEP 203, is adhered to the elastic sheet 260 through the adhesion layer 440 (STEP 407).

Next, the plunger sheet 280, which is formed by completing STEP 301, is adhered to the elastic sheet 260 through the adhesion layer 270 (STEP 408).

The thin keypad assembly and the method for manufacturing the same being thus described, it will be apparent that the same may be varied in many ways. Such variations are not to be regarded as a departure from the sprit and scope of the invention, and all such modifications as would be apparent to one of ordinary skill in the art are intended to be included within the scope of the following claims.

What is claimed is:

1. A thin keypad comprising:
an elastic sheet that is made of a resin or an elastomer; and
a group of keys including a plurality of keys that are formed from one key sheet through laser-cutting, and that are fixed on the elastic sheet as a laser-cut configuration, wherein
the plurality of keys is made of light curing resin with a thickness of 1.0 mm or less, and a narrowest spacing between the keys adjacent each other is equal to or less than 500 μM.

2. The thin keypad according to claim 1, further comprising:
a flange that is formed on a surface, which faces the elastic sheet, of the plurality of keys, and wherein
a thickness of the flange is equal to or less than 100 μm.

3. The thin keypad according to claim 1, further comprising:
a film that is formed on a rear surface of the plurality of keys.

4. The thin keypad according to claim 1, further comprising:
a frame that is provided at circumference of the group of keys, wherein
the plurality of keys includes a proximity key that is provided adjacent and opposite to a side of the frame, and at least one of the sides of the frame and at least one of the proximity keys are connected by at least one connection part per the proximity key.

5. The thin keypad according to claim 4, wherein
at least one of the sides of the frame and all the proximity keys that are provided adjacent to the side are connected by at least two connection parts per the proximity key.

6. The thin keypad according to claim 4, wherein
at least one of the sides of the frame and a central proximity key that is one of the proximity keys and that is located at the approximate center of the side in a longitudinal direction are connected by at least one connection part per the central proximity key.

7. The thin keypad according to claim 6, wherein
at least one of the sides of the frame and another proximity key adjacent to the central proximity key are connected by at least one connection part per the another proximity key.

8. The thin keypad according to claim 1, further comprising:
a decoration layer that includes at least one of thermosetting resin and light curing resin; and
an adhesion layer that is made of resin that can soften or melt by application of heat or pressure, wherein
the decoration layer and the adhesion layer are sequentially provided on a rear side of the plurality of keys, and the plurality of keys is bonded to the elastic sheet through the adhesion layer.

9. The thin keypad according to claim 1, wherein
a decoration layer that includes at least one of thermosetting resin and light curing resin is provided on a front side of the plurality of keys, an adhesion layer that is made of resin that can soften or melt by application of heat or pressure is provided on a rear side of the plurality of keys, and the plurality of keys is bonded to the elastic sheet through the adhesion layer.

10. A method for manufacturing a thin keypad comprising:
a resin supplying operation in which a light curing resin composition, which is in a non-cured state, is supplied into a mold;
a curing operation in which the light curing resin is cured by applying light to form a key sheet;
a cutting operation in which the key sheet is cut by a laser beam to form a group of keys including a plurality of keys, and
a fixing operation in which the group of keys is fixed to an elastic sheet that is made of resin or elastomer.

11. The method for manufacturing a thin keypad according to claim 10, wherein
the cutting operation is performed to prevent a position of the plurality of keys from changing after the cutting operation, and the fixing operation is performed to fix the group of keys to the elastic sheet with maintaining the as-cut position of the group of keys after the cutting operation.

12. The method for manufacturing a thin keypad according to claim 10, wherein
a film providing operation in which a film is provided on a surface of the light curing resin composition, which is in a non-cured state, opposite to the mold is performed between the resin supplying operation and the curing operation, and a film removing operation in which the film is removed is performed between the curing operation and the fixing operation.
